(19) United States
(12) Patent Application Publication
(10) Pub. No.: US 2009/0052713 A1
(43) Pub. Date: Feb. 26, 2009

(54) WIRELESS MICROPHONE SYSTEM

(76) Inventor: Ryoji Abe, Kanagawa (JP)

Correspondence Address: PEARNE & GORDON LLP, 1801 EAST 9TH STREET, SUITE 1200, CLEVELAND, OH, 44114-3108, US

(21) Appl. No.: 11/816,566

(22) PCT Filed: Feb. 20, 2006
(86) PCT No.: PCT/JP2006/302952

§ 371 Date: Aug. 17, 2007

(30) Foreign Application Priority Data
Feb. 24, 2005 (JP) 2005-049430

(51) Int. Cl. H04R 11/04

(52) U.S. Cl. 381/355

(57) ABSTRACT

A wireless microphone transmitter 1 and a wireless microphone receiver 12 can mutually communicate with each other. The wireless microphone receiver 12 transmits level meter data of sound data received by the wireless microphone receiver 12 to the wireless microphone transmitter 1. The wireless microphone transmitter 1 simultaneously displays a transmitter side sound level and a receiver side sound level. The user of the wireless microphone transmitter 1 sees the display of a wireless microphone on hand and can visually monitor the sound of transmission and reception. Instead of the sound level, an RF level may be monitored.

### TECHNICAL FIELD

The present invention relates to a wireless microphone system having a monitoring function of a sound level, a communication level or the like.

### BACKGROUND ART

Conventionally, a wireless microphone system has a function to perform monitoring of a sound level, a communication level or the like at an actual installation place. In the conventional wireless microphone system, such monitoring is mainly performed at the reception side.

FIG. 7 shows a structural example for sound monitoring provided in a receiver. In FIG. 7, a sound level signal is converted by an AD converter 30 into digital data which can be displayed on a level meter. A level meter display circuit 31 converts the digital data into a control signal suitable for a level meter display element. Then, a receiver side level meter display unit 32 receives the control signal and displays the level meter. By this, the sound data transmitted from a transmitter side can be monitored at the receiver side of the wireless microphone.

Besides, JP-A-2004-214757 (FIG. 1, etc.) discloses a wireless microphone receiver to display an RF level of sound reception by a structure similar to the above.

In the conventional wireless microphone system, the transmitter side of the wireless microphone system can not know whether reception is normally performed by the receiver. Then, in many cases, a speaker connected to the wireless receiver side and capable of outputting a sound is used, and a monitor sound is outputted to the user of the wireless microphone transmitter. However, in this case, from the structure of the equipment, there is a case where sound monitoring can not be easily performed. For example, in the case where the sound of the transmission side of the wireless microphone is monitored, it is necessary that a sound is outputted from the receiver side of the wireless microphone, the sound is inputted to an amplifier or the like, and its output is outputted from the speaker. As stated above, in addition to the wireless microphone system, the sound reinforcement system for monitoring is required, and therefore, the monitoring has not been simple. Besides, the sound and the radio state between the transmission and reception of the wireless microphone system has not been capable of being monitored by only the transmitter of the wireless microphone.

### DISCLOSURE OF THE INVENTION

### Problems that the Invention is to Solve

The invention has been made under the above background. An object of the invention is to provide a wireless microphone system in which an amplifier, a speaker and the like connected to a receiver for a wireless microphone are not required, and the state of sound, communication or the like of the wireless microphone can be simply monitored by a wireless microphone transmitter.

### Means for Solving the Problems

An aspect of the invention relates to a wireless microphone system including a wireless microphone transmitter and a wireless microphone receiver which can mutually communicate with each other, the wireless microphone transmitter includes a sound input unit, a sound data transmission unit to send an inputted sound to the wireless microphone receiver, a transmission side level meter data generation unit to generate level meter data of transmission side monitoring, a level meter data reception unit to receive level meter data of reception side monitoring from the wireless microphone receiver side, and a level meter display unit to display the level meter data of the transmission side monitoring generated by the transmission side level meter data generation unit and the level meter data of the reception side monitoring received by the level meter data reception unit, and the wireless microphone receiver includes a sound data reception unit, a reception side level meter data generation unit to generate the level meter data of the reception side monitoring, and a level meter data transmission unit to transmit the level meter data of the reception side monitoring generated by the reception side level meter data generation unit to the wireless microphone transmitter side.

Another aspect of the invention relates to a wireless microphone system including a wireless microphone transmitter and a wireless microphone receiver which can mutually communicate with each other, the wireless microphone transmitter includes a sound input unit, a sound data transmission unit to send an inputted sound to the wireless microphone receiver, a transmission side level meter data generation unit to generate level meter data of transmission side monitoring, a level meter data reception unit to receive level meter data of reception side monitoring from the wireless microphone receiver side, a subtraction unit to subtract the level meter data of the reception side monitoring received by the level meter data reception unit from the level meter data of the transmission side monitoring generated by the transmission side level meter data generation unit, and a difference amount display unit to display difference data acquired by the subtraction unit, and the wireless microphone receiver includes a sound data reception unit, a reception side level meter data generation unit to generate the level meter data of the reception side monitoring, and a level meter data transmission unit to transmit the level meter data of the reception side monitoring generated by the reception side level meter data generation unit to the wireless microphone transmitter side.

Another aspect of the invention relates to a wireless microphone transmitter, and this transmitter, together with a wireless microphone receiver, constitutes a wireless microphone system and capable of mutually communicating with the wireless microphone receiver and including a sound input unit, a sound data transmission unit to send an inputted sound to the wireless microphone receiver, a transmission side level meter data generation unit to generate level meter data of transmission side monitoring, a level meter data reception unit to receive level meter data of reception side monitoring from the wireless microphone receiver side, and a level meter display unit to display the level meter data of the transmission side monitoring generated by the transmission side level meter data generation unit and the level meter data of the reception side monitoring received by the level meter data reception unit.

As described hereafter, other aspects of the invention exist. Thus, this summary of the invention is intended to provide a few aspects of the invention and is not intended to limit the scope of the invention described and claimed herein.

### BRIEF DESCRIPTION OF THE DRAWINGS

FIG. 1 is a schematic block diagram of a wireless microphone system of a first embodiment of the invention.

FIG. 2 is a view of a level meter display example of a wireless microphone transmitter of the first embodiment of the invention.

FIG. 3 is a block diagram of a structure in which the sampling frequency and data length of level meter display data are fixed.

FIG. 4 is a schematic block diagram of a wireless microphone system of a second embodiment of the invention.

FIG. 5 is a schematic block diagram of a wireless microphone system of a third embodiment of the invention.

FIG. 6 is a schematic block diagram of a wireless microphone system of a fourth embodiment of the invention.

FIG. 7 is a view showing a conventional example.

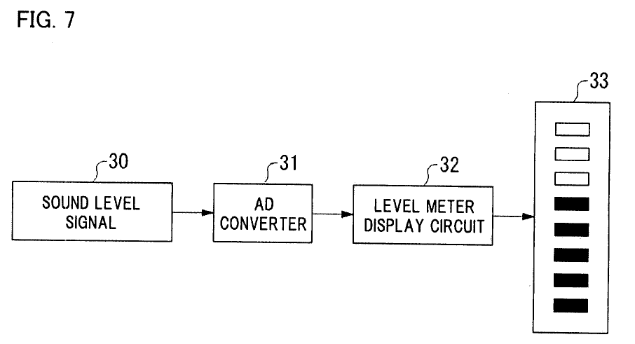

### DESCRIPTION OF REFERENCE NUMERALS AND SINGS

1: wireless microphone transmitter
2: microphone
3: AD converter
4: sound data transmission unit
5: sound filter
6: data bit length down converter
7: sampling frequency down converter
8: transmission data level meter display unit
9: level meter data reception unit,
10: radio transmission/reception unit
11: reception data level meter display unit
12: wireless microphone receiver
13: sound data reception unit
14: level meter data transmission unit
15: radio transmission/reception unit
16: DA converter
17: sound output unit
18: sound filter
19: down conversion unit
20: sampling frequency data
21: data bit length data
22: encoding processing unit
23: delay unit
24: subtraction unit
25: subtraction result display unit
26: transmission RF level detection unit
27: transmission RF display filter, unit
28: reception RF level detection unit
29: reception RF display filter unit

### BEST MODE FOR CARRYING OUT THE INVENTION

Hereinafter, the invention will be described in detail. However, the following detailed description and the attached drawings do not limit the invention. Instead, the scope of the invention is defined by the attached claims.

A wireless microphone system includes a wireless microphone transmitter and a wireless microphone receiver which can mutually communicate with each other. The wireless microphone transmitter includes a sound input unit, a sound data transmission unit to send an inputted sound to the wireless microphone receiver, a transmission, side level meter data generation unit to generate level meter data of transmission side monitoring, a level meter data reception unit to receive level meter data of reception side monitoring from the wireless microphone receiver side, and a level meter display unit to display the level meter data of the transmission side monitoring generated by the transmission side level meter data generation unit and the level meter data of the reception side monitoring received by the level meter data reception unit. The wireless microphone receiver includes a sound data reception unit, a reception side level meter data generation unit to generate the level meter data of the reception side monitoring, and a level meter data transmission unit to transmit the level meter data of the reception side monitoring generated by the reception side level meter data generation unit to the wireless microphone transmitter side.

By this structure, the wireless microphone system has the mutual communication function. The mutual communication function is used, and the level meter data is transmitted from the wireless microphone receiver to the wireless microphone transmitter, and the level meter data of the transmission/reception side are displayed by the wireless microphone transmitter. Accordingly, at the wireless microphone transmitter side, the levels of the monitor object at the transmitter side and the receiver side of the wireless microphone can be visually simultaneously monitored.

The transmission side level meter data generation unit may include a filter unit to convert the sound data inputted from the sound input unit into the level meter data. The reception side level meter data generation unit may include a filter unit to convert the received sound data into the level meter data.

By this structure, at the wireless microphone transmitter side, the sound level of the transmitter side and the receiver side of the wireless microphone can be visually simultaneously monitored.

Besides, the wireless microphone transmitter may include a transmission RF level detection unit to detect a transmission RF level of the sound data transmission unit. The transmission side level meter data generation unit may include a filter unit to convert the transmission RF level into the level meter data. The wireless microphone receiver may include a reception RF level detection unit to detect a reception RF level of the sound data reception unit. The reception side level meter data generation unit may include a filter unit to convert the reception RF level into the level meter data.

By this structure, at the wireless microphone transmitter side, the radio state between the transmission and reception of the wireless microphone system can be monitored.

Besides, the wireless microphone transmitter may include, as the level meter display unit, a transmission data level meter display unit and a reception data level meter display unit. Further, the wireless microphone transmitter may include, at the front stage of the transmission data level meter display unit, a delay unit to delay the display of the level meter data of the transmission side monitoring onto the transmission data level meter display unit by a delay time corresponding to a transmission/reception time between the wireless microphone transmitter and the wireless microphone receiver.

By this structure, a phase difference on the display between the transmission data level meter display unit and the reception data level meter display unit is reduced, and the data at the same time point can be displayed.

Besides, the wireless microphone receiver may include a subtraction unit to subtract the level meter data of the reception side monitoring received by the level meter data reception unit from the level meter data of the transmission side monitoring generated by the transmission side level meter data generation unit. The level meter display unit may be constructed to display difference data acquired by the subtraction unit.

By this structure, the difference of the level of the monitor object between the transmission and the reception can be displayed, and abnormalities of a transmission state and the like can be notified to the user of the wireless microphone receiver.

Besides, a wireless microphone system according to another aspect includes a wireless microphone transmitter and a wireless microphone receiver which can mutually communicate with each other. The wireless microphone transmitter includes a sound input unit, a sound data transmission unit to send an inputted sound to the wireless microphone receiver, a transmission side level meter data generation unit to generate level meter data of transmission side monitoring, a level meter data reception unit to receive level meter data of reception side monitoring from the wireless microphone receiver side, a subtraction unit to subtract the level meter data of the reception side monitoring received by the level meter data reception unit from the level meter data of the transmission side monitoring generated by the transmission side level meter data generation unit, and a difference amount display unit to display difference data acquired by the subtraction unit. The wireless microphone receiver includes a sound data reception unit, a reception side level meter data generation unit to generate the level meter data of the reception side monitoring, and a level meter data transmission unit to transmit the level meter data of the reception side monitoring generated by the reception side level meter data generation unit to the wireless microphone transmitter side. By this structure, the difference of the level of the monitor object between the transmission and the reception can be displayed, and abnormalities of a transmission state and the like can be notified to the user of the wireless microphone receiver.

As described above, in the invention, the mutual communication function is used, and the monitor levels of the transmission and reception can be displayed at the transmitter side of the wireless microphone. Accordingly, even if sound reinforcement using a speaker or the like is not performed, monitoring can be simply performed by the transmitter held by the hand of the user of the wireless microphone.

Hereinafter, embodiments of the invention will be described with reference to the drawings.

### FIRST EMBODIMENT

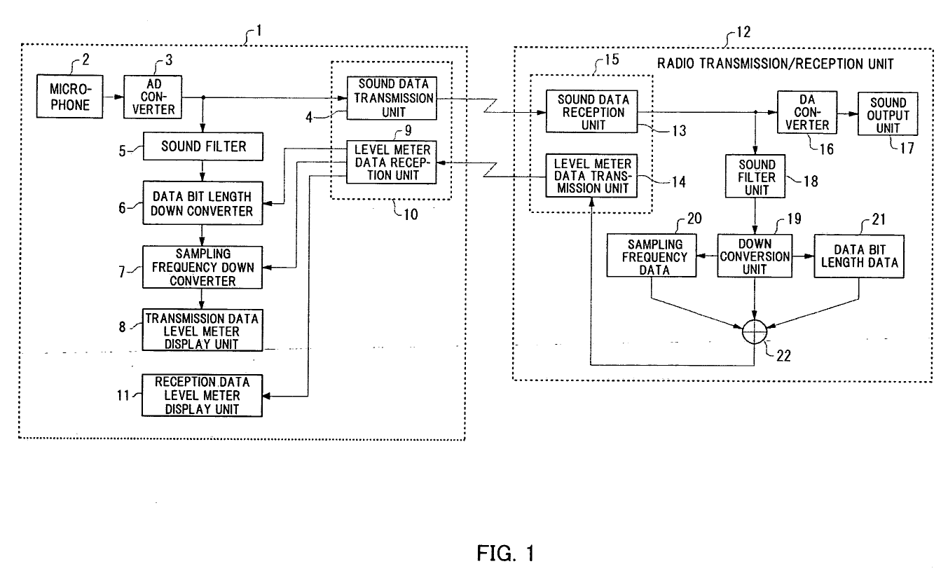

FIG. 1 shows a wireless microphone system of a first embodiment of the invention. In the first embodiment, a sound level is monitored.

As shown in FIG. 1, the wireless microphone system of the first embodiment of the invention includes a wireless microphone transmitter 1 and a wireless microphone receiver 12 which can mutually communicate with each other.

The wireless microphone transmitter 1 includes a microphone 2 to input a sound, an AD converter 3 to convert the inputted sound into digital sound data, a sound data transmission unit 4 to transmit the sound data converted by the AD converter 3 to the wireless microphone receiver 12 side, a sound filter 5 to convert the sound data outputted by the AD converter into a display response for level meter display (level meter data), a data bit length down converter 6 to down-convert the output data of the sound filter 5 into a specified bit length, a sampling frequency down converter 7 to convert the output data of the sound filter 5 into a sampling frequency necessary for the level meter display, a transmission data level meter display unit 8 to display the data converted into the level meter display data by the sampling frequency down converter 7 by using an LED or the like, and a level meter data reception unit 9 to receive level meter data transmitted from the wireless microphone receiver 12 side. The sound data transmission unit 4 and the level meter data reception unit 9 constitute a radio transmission/reception unit 10 of the wireless microphone transmitter side. Besides, the wireless microphone transmitter 1 includes a reception data level meter display unit 11 to display the level meter data received by the level meter data reception unit 9 by using an LED or the like.

The wireless microphone receiver 12 includes a sound data reception unit 13 to receive a radio wave transmitted from the wireless microphone transmitter 1, a DA converter 16 to DA convert the received data, a sound output unit 17 to output the data subjected to the DA conversion, as an analog sound signal, to an outer equipment, a sound filter unit 18 used for converting the sound data received by the sound data reception unit 13 into level meter display data, and a down conversion unit 19 to convert the output data of the sound filter unit 18 into data having a specified data bit length and a specified sampling frequency. The down conversion unit 19 corresponds to the data bit length down converter and the sampling frequency down converter of the transmission side. In the drawing, the sampling frequency data and the data bit length used for the down conversion are indicated by blocks denoted by reference numerals 20 and 21. Further, the wireless microphone receiver 12 includes an encoding processing unit 22 to add the output data of the down convert unit 19 (level meter data), the sampling frequency data 20 and the bit length data 21 to a transmission frame, and a level meter data transmission unit 14 to transmit the level meter data processed by the encoding processing unit 22 to the wireless microphone transmitter 1. The sound data reception unit 13 and the level meter data transmission unit 14 constitute a radio transmission/reception unit 15 of the wireless microphone receiver 12.

Next, the operation of the wireless microphone system of the first embodiment will be described. The sound inputted from the microphone 2 is converted into the digital sound signal by the AD converter 3. The digital sound signal is subjected to the encoding processing and the frame processing by the sound data transmission unit 4 so that the digital wireless transmission can be performed. The wireless microphone transmitter 1 transmits the digital data as a radio wave by the sound data transmission unit 4.

On the other hand, the level meter data is acquired from the wireless microphone receiver 12 side by the level meter data reception unit 9. The data received by the level meter data reception unit 9 is added with the data bit length data and the sampling frequency data of the level meter. By extracting the added data bit length data of the level meter, the data bit length of the level meter at the wireless microphone transmitter side is set. Similarly, by extracting the sampling frequency data, the sampling frequency of the level meter at the wireless microphone transmitter 1 side is set. In this processing, the data bit length data is supplied to the data bit length down converter 6, and the sampling frequency data is supplied to the sampling frequency down converter 7.

In order to perform the level meter display, the digital sound signal as the output of the AD converter 3 is inputted to the sound filter 5 as the digital filter constituting an integrator having a specified time constant. The output data of the sound filter 5 is processed by the data bit length down converter 6 while the data bit length for the level meter acquired by the level meter data reception unit 9 is used, and the data length is down-converted. Besides, the output data of the sound filter 5 is processed by the sampling frequency down converter 7 while the sampling frequency data for the level meter acquired by the level meter data reception unit 9 is used, and the down conversion of the sampling frequency is performed.

The data generated in this way as the data for display of the level meter is displayed on the level meter by using a light emitting element, such as an LED, or an LCD of the transmission data level meter display unit 8.

Besides, the level meter data of the wireless microphone receiver 12 side acquired by the level meter data reception unit 9 is also displayed on the level meter using a light emitting element, such as an LED, or an LCD of the reception data level meter display unit 11.

By this display, the user of the wireless microphone transmitter 1 can simultaneously visually monitor the sound generated by the user himself/herself and the sound level received by the wireless microphone receiver 12.

Next, a description will be made on how the level meter data to be received by the wireless microphone transmitter 1 side is generated by the wireless microphone receiver 12 side. The digital sound data transmitted from the wireless microphone transmitter 1 side is received by the sound data reception unit 13 of the wireless microphone receiver 12 side. The received sound data is inputted to the sound filter 18 for the level meter. The sound data is subjected to a response processing by the sound filter 18 as the digital filter constituting the integrator having the specified time constant for performing the level meter display, and the processed data is outputted. The output data is down-converted with the specified data bit length and the specified sampling frequency by the down conversion unit 19. The down-converted level meter data, together with the sampling frequency data 20 and the data bit length 21, is encoded by the encoding processing unit 22 into data capable of being transmitted to the wireless microphone transmitter 1. The encoded level meter data is transmitted by the level meter data transmission unit 14 from the wireless microphone receiver 12 to the wireless microphone transmitter 1.

In this way, at the wireless microphone transmitter 1 side, the sound level at the wireless microphone transmitter 1 side and the sound level at the wireless microphone receiver 12 side can be simultaneously visually monitored.

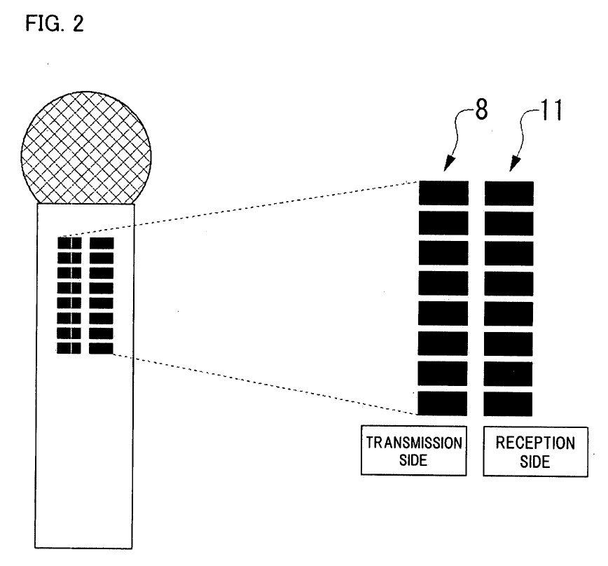

FIG. 2 shows a specific example of the transmission data level meter display unit 8 and the reception data level meter display unit 11 provided on the wireless microphone transmitter 1. FIG. 2 shows the display example of the case where the transmission data level meter display unit 8 includes 8 LED elements, and the reception data level meter display unit 11 includes 8 LED elements. When the level data is inputted, an LED of a relevant bit is turned on. The line of the LEDs becomes the level meter in which the level state can be determined by the lighting state.

In this way, the display of the level meter is performed by the transmitter 1 held by the hand of the user of the wireless microphone. Accordingly, the user of the wireless microphone can simply monitor the transmission side level and the reception side level relating to the sound generated by the user himself/herself near the hand holding the microphone. Differently from a general wireless microphone system in which sound monitoring is performed at the receiver side, in the invention, the sound check can be made at the transmitter side.

Besides, in the embodiment, the data bit length and the sampling frequency of the level meter at the wireless microphone receiver side can be made variable by the rate of the digital sound data. For example, in the case where the rate of the digital sound data is doubled, the rate of the data bit length and the sampling frequency of the level meter is controlled to be small. By this, the amount of data transmitted from the wireless microphone receiver side to the wireless microphone transmitter side can be reduced. By this, while the rate of the digital sound data is ensured, monitoring by the level meters at the transmitter side and the receiver side becomes possible.

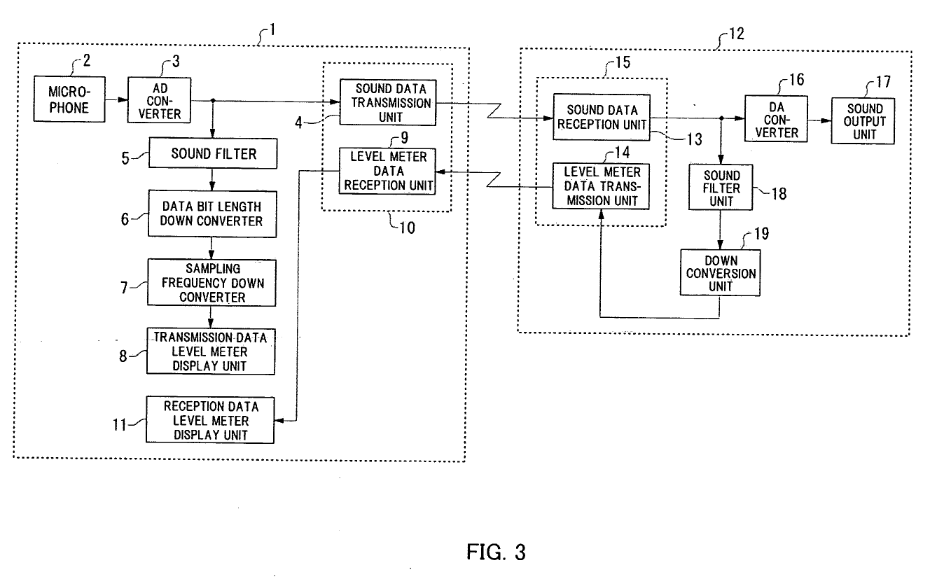

Incidentally, in FIG. 1, the wireless microphone transmitter 1 acquires the data bit length data and the sampling frequency data of the level meter from the wireless microphone receiver 12 side. However, the data bit length and the sampling frequency of the level meter may be fixed between the transmission and the reception of the wireless microphone system. In this case, as in a structural example of FIG. 3, it becomes unnecessary to transmit the data bit length and the sampling frequency data of the level meter between the transmission and reception of the wireless microphone. The same applies to following embodiments, and the data bit length and the sampling frequency may be fixed and may not be transmitted and received.

Besides, in this embodiment, the level meter display is performed by using the plural LEDs corresponding to data of plural bits. However, it is also possible to perform the level meter display by turning on one display member, for example, only one LED. In this case, not a level amount, but a lighting threshold level at the time of lighting and non-lighting is previously set. Then, a sound level exceeds the threshold, the LED is turned on. By this, it is monitored whether the sound of the specified level or higher is inputted.

Besides, in this embodiment, the wireless receiver 12 DA-converts the digital data and then outputs it. However, when an external equipment is a digital input equipment, the digital data may be outputted without performing the DA conversion.

Besides, although this embodiment assumes that the wireless microphone system uses digital transmission, the invention may be realized in an analog wireless microphone system using analog signal transmission.

As described above, according to the wireless microphone system of the first embodiment, the wireless microphone system is provided with the mutual communication function. The level meter data is transmitted from the wireless microphone receiver to the wireless microphone transmitter by using the mutual communication function, and the level meter data at the transmission/reception sides are displayed by the wireless microphone transmitter. Accordingly, at the wireless microphone transmitter side, the levels of the monitor object of the transmitter side and the receiver side of the wireless microphone can be visually simultaneously monitored.

According to the wireless microphone system of the first embodiment, especially the sound levels at the transmitter side and the receiver side can be visually simultaneously monitored.

### SECOND EMBODIMENT

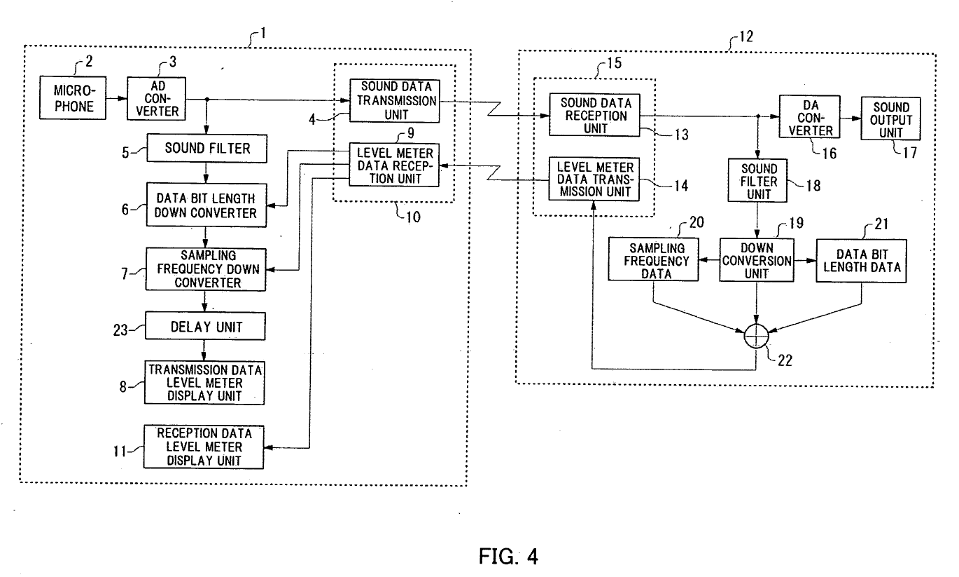

FIG. 4 shows a wireless microphone system of a second embodiment of the invention. The wireless microphone system of the second embodiment is substantially the same as the first embodiment, except for the following description (description of the same matter as that of the first embodiment will be omitted).

The second embodiment is different from the first embodiment in that processing of a delay unit 23 is inserted just before processing of a transmission data level meter display unit 8 of a wireless microphone transmitter side. The delay unit 23 is realized by writing/reading processing on a memory such as a DRAM. The delay unit 23 delays data display onto the transmission data level meter display unit 8 by a delay time equivalent to a transmission/reception time between a wireless microphone transmitter 1 and a wireless microphone receiver 12. For example, in the case where a reciprocating delay time amount between the wireless microphone transmitter 1 and the wireless microphone receiver 12 is 4 ms, the level meter data of the transmission side sound is delayed by 4 ms by the delay unit 23, and then is supplied to the transmission data level meter display unit 8, and, the level meter display is performed. By this, the level meter displays of the transmitter side and the receiver side of the wireless microphone can be performed at the same phase. Then, there is obtained an effect of facilitating visual recognition of the difference in the level between the transmitter side and the receiver side.

### THIRD EMBODIMENT

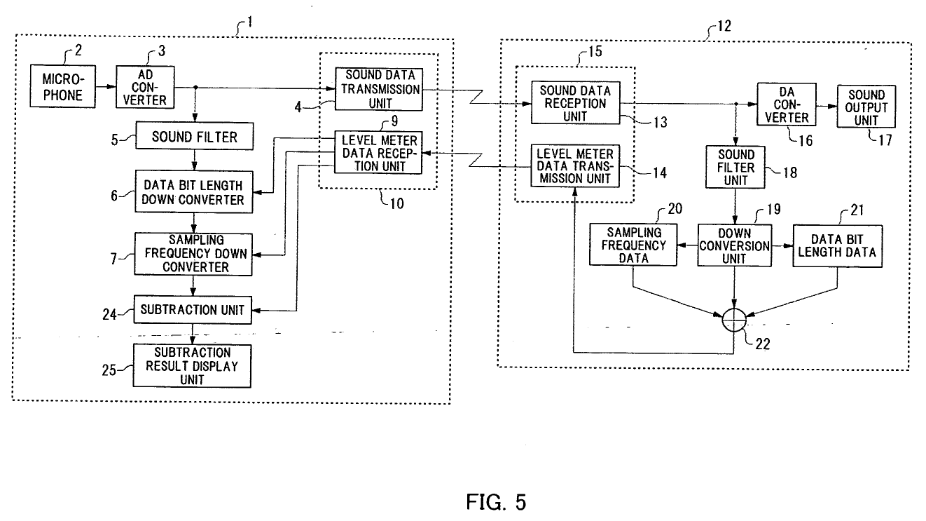

FIG. 5 shows a wireless microphone system of a third embodiment of the invention. The wireless microphone system of the third embodiment is substantially the same as the first embodiment, except for the following description (description of the same matter as that of the first embodiment will be omitted).

The third embodiment is the different from the first embodiment in that a wireless microphone system is constructed such that that difference data between level meter data at a transmitter side and level meter data at a receiver is displayed on a level meter.

In more detail, a wireless microphone transmitter 1 includes a subtraction unit 24 and a subtraction result display unit (difference amount display unit) 25. The subtraction unit 24 subtracts level meter date at a wireless microphone receiver 12 side from level meter data at the wireless microphone transmitter 1 side. Then, the subtraction result display unit 25 displays the difference data obtained by the subtraction unit 24 as the difference amount of sound data between transmission and reception. The subtraction result display unit 25 may include LED lines similarly to the first embodiment (one LED line may be provided). By this, attention is paid to the difference of the sound level between the transmitter and the receiver of the wireless microphone, and it becomes possible to monitor whether the specified sound level is achieved at the receiver side. In the case where the sound is normally transmitted from the transmitter side to the receiver side, nothing is displayed on the subtraction result display unit 25. However, in the case where an abnormality occurs in the transmission/reception state, the difference level amount is displayed on the subtraction result display unit 25. The difference display becomes an alarm display, and can issue a warning to the user.

As stated above, in this system, the difference of the sound level between the transmitter side and the receiver side can be recognized by the level display of the one level meter display unit. Accordingly, the user can easily know the sound and transmission state. In the case where a difference occurs, that is, in the case where an abnormality occurs, the level meter display appears. Then, the user of the wireless microphone transmitter sees the display of the microphone on hand and can instantaneously recognize the abnormality.

In the above, the third embodiment has been described. According to the third embodiment, the difference of the level of the monitor object between the transmission and the reception can be displayed, and the abnormality can be notified to the user of the wireless microphone receiver.

### FOURTH EMBODIMENT

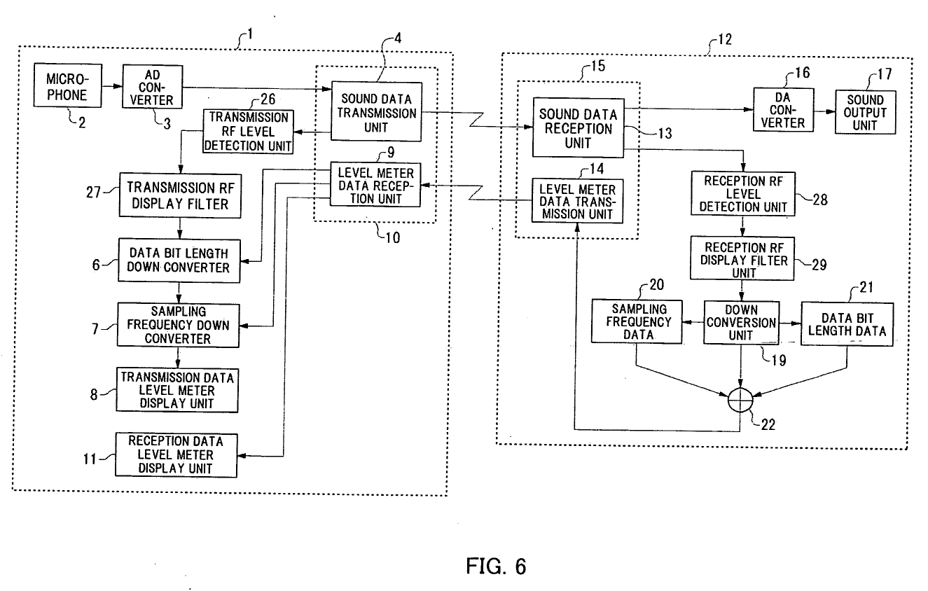

FIG. 6 shows a wireless microphone system of a fourth embodiment of the invention. The wireless microphone system of the fourth embodiment is substantially the same as the first embodiment, except for the following description (description of the same matter as that of the first embodiment will be omitted).

The fourth embodiment is different from the first embodiment in a monitoring object. In the first embodiment, the sound level is monitored, however, in the fourth embodiment, a communication state is monitored, and in more detail, an RF level is monitored.

In FIG. 6, a wireless microphone transmitter 1 includes a transmission RF level detection unit 26 and a transmission RF display filter 27. The RF amount (or value) transmitted from the wireless microphone transmitter 1 is determined by a sound data transmission unit 4 of the wireless microphone transmitter 1. This RF amount is converted into RF level data by the transmission RF level detection unit 26. The converted RF level data is converted into level meter data having an optimum time constant as a display response by the transmission RF display filter 27, and is outputted as a filter output value. This level meter data is supplied to a data bit length down converter 6 and the like similarly to the foregoing embodiment, is processed and is displayed.

Besides, a wireless microphone receiver 12 includes a reception RF level detection unit 28 and a reception RF display filter 29. The reception RF level is acquired by the reception RF level detection unit 28. The RF level data is inputted to the reception RF display filter 29, and is converted into level meter data having an optimum time constant for level meter display. This data is transmitted to the wireless microphone transmitter 1 side similarly to the description of the foregoing embodiment. Here, the level meter data is processed by a down conversion unit 19 and an encoding processing unit 22, and is transmitted from a level meter data transmission unit 14.

In the wireless microphone transmitter 1, the transmission RF data is displayed on a transmission data level meter display unit 8, and the reception RF data is displayed on a reception data level meter display unit 11. By this, it becomes possible to monitor the reception RF level on the wireless microphone transmitter 1 at the same time as the transmission RF level. The user of the wireless microphone transmitter 1 sees the level meter display of the wireless microphone on hand without seeing the display at the receiver side, and can use the wireless microphone while confirming the radio state.

As described above, according to the fourth embodiment, at the wireless microphone transmitter side, the sound levels of the wireless microphone at the transmitter side and the receiver side can be visually simultaneously monitored.

Incidentally, also in the case of the display of the transmission/reception RF levels, similarly to the second embodiment, a delay unit is provided at the processing side of the transmission RF level, and transmission/reception RF display of the same phase may be performed. The delay unit is provided at the front stage of the transmission data level meter display unit 8 similarly to the second embodiment.

Besides, also in the case of the display of the transmission/reception RF levels, similarly to the third embodiment, a difference between the transmission RF level and the reception RF level may be displayed. In this case, similarly to the third embodiment, the wireless microphone transmitter 1 includes a subtraction unit and a subtraction result display unit. By this, the level meter display of a difference amount is performed as the deterioration level of a radio state. Then, the alarm of the radio state deterioration can be issued.

Although the preferred embodiments of the invention conceivable at the present time point have been described, it would be understood that various modifications can be made to the embodiments, and it is intended that the scope of the attached claims include all such modifications within the true sprit and scope of the invention.

### INDUSTRIAL APPLICABILITY

As described above, the invention is useful since the states at the transmission/reception sides can be simply monitored by the wireless microphone transmitter.

1. A wireless microphone system comprising a wireless microphone transmitter and a wireless microphone receiver which can mutually communicate with each other, wherein, the wireless microphone transmitter includes:
a sound input unit;
a sound data transmission unit to send an inputted sound to the wireless microphone receiver;
a transmission side level meter data generation unit to generate level meter data of transmission side monitoring;
a level meter data reception unit to receive level meter data of reception side monitoring from the wireless microphone receiver side; and
a level meter display unit to display the level meter data of the transmission side monitoring generated by the transmission side level meter data generation unit and the level meter data of the reception side monitoring received by the level meter data reception unit, and
the wireless microphone receiver includes:
a sound data reception unit;
a reception side level meter data generation unit to generate the level meter data of the reception side monitoring; and
a level meter data transmission unit to transmit the level meter data of the reception side monitoring generated by the reception side level meter data generation unit to the wireless microphone transmitter side.

2. The wireless microphone system according to claim 1, wherein the transmission side level meter data generation unit includes a filter unit to convert sound data inputted from the sound input unit into the level meter data, and the reception side level meter data generation unit includes a filter unit to convert received sound data into the level meter data.

3. The wireless microphone system according to claim 1, wherein the wireless microphone transmitter includes a transmission RF level detection unit to detect a transmission RF level of the sound data transmission unit, the transmission side level meter data generation unit includes a filter unit to convert the transmission RF level into the level meter data, the wireless microphone receiver includes a reception RF level detection unit to detect a reception RF level of the sound data reception unit, and the reception side level meter data generation unit includes a filter unit to convert the reception RF level into the level meter data.

4. The wireless microphone system according to claim 1, wherein the wireless microphone transmitter includes a transmission data level meter display unit and a reception data level meter display unit as the level meter display unit, and includes, at a front stage of the transmission data level meter display unit, a delay unit to delay displaying the level meter data of the transmission side monitoring onto the transmission data level meter display unit by a delay time corresponding to a transmission/reception time between the wireless microphone transmitter and the wireless microphone receiver.

5. The wireless microphone system according to claim 1, wherein the wireless microphone receiver includes a subtraction unit to subtract the level meter data of the reception side monitoring received by the level meter data reception unit from the level meter data of the transmission side monitoring generated by the transmission side level meter data generation unit, and the level meter display unit displays difference data acquired by the subtraction unit.

6. A wireless microphone system comprising a wireless microphone transmitter and a wireless microphone receiver which can mutually communicate with each other, wherein, the wireless microphone transmitter includes:
a sound input unit;
a sound data transmission unit to send an inputted sound to the wireless microphone receiver;
a transmission side level meter data generation unit to generate level meter data of transmission side monitoring;
a level meter data reception unit to receive level meter data of reception side monitoring from the wireless microphone receiver side;
a subtraction unit to subtract the level meter data of the reception side monitoring received by the level meter data reception unit from the level meter data of the transmission side monitoring generated by the transmission side level meter data generation unit; and
a difference amount display unit to display difference data acquired by the subtraction unit, and
the wireless microphone receiver includes:
a sound data reception unit;
a reception side level meter data generation unit to generate the level meter data of the reception side monitoring; and
a level meter data transmission unit to transmit the level meter data of the reception side monitoring generated by the reception side level meter data generation unit to the wireless microphone transmitter side.

7. A wireless microphone transmitter which, together with a wireless microphone receiver, constitutes a wireless microphone system and can mutually communicate with the wireless microphone receiver, the wireless microphone transmitter comprising:
a sound input unit;
a sound data transmission unit to send an inputted sound to the wireless microphone receiver;
a transmission side level meter data generation unit to generate level meter data of transmission side monitoring;
a level meter data reception unit to receive level meter data of reception side monitoring from the wireless microphone receiver side; and
a level meter display unit to display the level meter data of the transmission side monitoring generated by the transmission side level meter data, generation unit and the level meter data of the reception side monitoring received by the level meter data reception unit.
